(19) United States
(12) Patent Application Publication
(10) Pub. No.: US 2014/0062908 A1
(43) Pub. Date: Mar. 6, 2014

(54) TOUCH PANEL AND METHOD FOR MANUFACTURING THE SAME

(71) Applicant: SAMSUNG ELECTRO-MECHANICS CO., LTD., Gyunggi-do (KR)

(72) Inventor: Seung Hyun Ra, Gyunggi-do (KR)

(73) Assignee: SAMSUNG ELECTRO-MECHANICS CO., LTD., Gyunggi-do (KR)

(21) Appl. No.: 13/711,508

(22) Filed: Dec. 11, 2012

(30) Foreign Application Priority Data
Sep. 3, 2012 (KR) 10-2012-0097240

(51) Int. Cl. G06F 3/041

(52) U.S. Cl. CPC G06F 3/041
USPC 345/173

(57) ABSTRACT

Disclosed herein is a touch panel including a transparent substrate divided into an active region and a non-active region as an edge of the active region, a printing layer formed in the non-active region of one surface of the transparent substrate, an adhesive film formed to cover the printing layer on one surface of the transparent substrate, an insulating layer formed on one surface of the adhesive film and having an intaglio portion open toward one surface thereof, and an electrode formed within the intaglio portion.

### CROSS REFERENCE TO RELATED APPLICATION

This application claims the benefit of Korean Patent Application No. 10-2012-0097240, filed on Sep. 3, 2012, entitled “Touch Panel and Method for Manufacturing the Same”, which is hereby incorporated by reference in its entirety into this application.

### BACKGROUND OF THE INVENTION

1. Technical Field

The present invention relates to a touch panel and a method for manufacturing the same.

2. Description of the Related Art

Due to the development of computers using digital technologies, computer assisted devices have also been developed, and personal computers, portable transmission devices, and other personal dedicated information processing devices perform text and graphic processing by using various input devices such as a keyboard or a mouse.

However, the rapid transition into the information-oriented society has extended the purpose of computers, such that a currently used keyboard and mouse serving as input devices are insufficient to effectively drive products. Thus, demand for a device allowing any one to easily input information, as well as being simple and reducing possibility of erroneous manipulation, is increasing.

In addition, interest in techniques regarding an input device, beyond a level satisfying general functions, has been shifted to reliability, durability, innovativeness, designing, processing-related technique, and the like, and in order to achieve such objects, a touch panel (or a touch screen) allowing for input information such as text, graphics, and the like, has been developed as an input device.

A touch panel is a tool installed on a display screen of a flat panel display device such as an electronic notebook, a liquid crystal display (LCD) device, a plasma display panel (PDP), an electroluminescence (EL), or the like, and an image display device such as a cathode ray tube (CRT), or the like, to allow users to select desired information while viewing the image display device.

Types of touch panels are classified into a resistive type touch panel, a capacitive type touch panel, an electro-magnetic type touch panel, a surface acoustic wave (SAW) type touch panel, and an infrared type touch panel. The various types of touch panels are employed in electronic products in consideration of issues such as signal amplification, a difference in resolution, a level of difficulty in a designing and processing technique, optical properties, electrical properties, mechanical properties, environment resistance properties, input properties, durability, economic efficiency, and among them, currently the resistive type touch panel and the capacitive type touch panel are used in the most extensive fields.

In a touch panel, an electrode layer is generally made of indium tin oxide (ITO), and a specific example of a touch panel including an electrode layer made of ITO may be a touch panel disclosed in Korean Patent No. 10-1074263.

However, ITO has excellent electric conductivity, but indium as a material is a costly rare earth metal. Also, indium is expected to be depleted within 10 years, so its supply and demand are not balanced.

For this reason, research into a formation of an electrode layer using a metal has been actively conducted.

Meanwhile, in this document as disclosed, a touch panel thereof is formed to have a printing layer in black, white, or the like, that may cover an electrode wiring or may have a decorative pattern formed thereon on window glass provided on the outermost region of the touch panel structure.

However, since the printing layer is formed on the window glass in the related art touch panel, a step exists on one surface of the window glass due to the printing layer. Also, an electrode layer formed on one surface of the window glass is highly likely to be disconnected during a process of forming the electrode layer due to the step caused by the printing layer.

Of course, when the electrode layer is made of ITO as that of the related art touch panel, a disconnection problem, in spite of the step existing in the printing layer, may be solved to a degree. However, ITO has a problem related to a material as mentioned above.

Thus, a method for improving a structure of the touch panel that may solve the disconnection problem of the electrode layer in spite of the step due to the printing layer in the case in which the electrode layer is made of a metal, rather than ITO, is required to be devised.

### SUMMARY OF THE INVENTION

The present invention has been made in an effort to provide a touch panel in which a problem of disconnection of an electrode layer does not occur in spite of a step due to a printing layer, and a method for manufacturing the same.

According to a preferred embodiment of the present invention, there is provided a touch panel including: a transparent substrate divided into an active region and a non-active region as an edge of the active region; a printing layer formed in the non-active region of one surface of the transparent substrate; an adhesive film formed to cover the printing layer on one surface of the transparent substrate; an insulating layer formed on one surface of the adhesive film and having an intaglio portion open toward one surface thereof; and an electrode formed within the intaglio portion.

The adhesive film may include a silane coupling agent.

The insulating layer may be made of a thermosetting resin or a UV-curing resin.

The electrode may be made of a metal of any one of copper (Cu), aluminum (Al), gold (Au), silver (Ag), titanium (Ti), palladium (Pd), and chromium (Cr), or any combination thereof.

The transparent substrate may be window glass.

According to another preferred embodiment of the present invention, there is provided a method for manufacturing a touch panel, including: step (A) of preparing a transparent substrate; step (B) of forming a printing layer on a non-active region of one surface of the transparent substrate; step (C) of forming an adhesive film on one surface of the transparent substrate such that it covers the printing layer; step (D) of forming an insulating layer on one surface of the adhesive film; step (E) of forming an intaglio portion on one surface of the insulating layer; and step (F) of forming an electrode within the intaglio portion.

The adhesive film may include a silane coupling agent.

In step (C), the adhesive film may be formed by applying a silane coupling agent in a spray manner to one surface of the transparent substrate.

The insulating layer may be made of a thermosetting resin or a UV-curing resin.

In step (E), the intaglio portion may be formed by patterning the insulating layer with a stamp.

The electrode may be made of a metal of any one of copper (Cu), aluminum (Al), gold (Au), silver (Ag), titanium (Ti), palladium (Pd), and chromium (Cr), or any combination thereof.

In step (F), the electrode may be formed by evaporating or plating a metal within the intaglio portion.

The transparent substrate may be window glass.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a plan view illustrating a transparent substrate included in a touch panel according to an embodiment of the present invention;

FIG. 2 is a cross-sectional view of the touch panel according to an embodiment of the present invention; and

FIGS. 3 to 7 are cross-sectional views sequentially showing a process of manufacturing a touch panel illustrated in FIG. 2.

### DESCRIPTION OF THE PREFERRED EMBODIMENTS

The objects, features, and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side”, and the like, are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

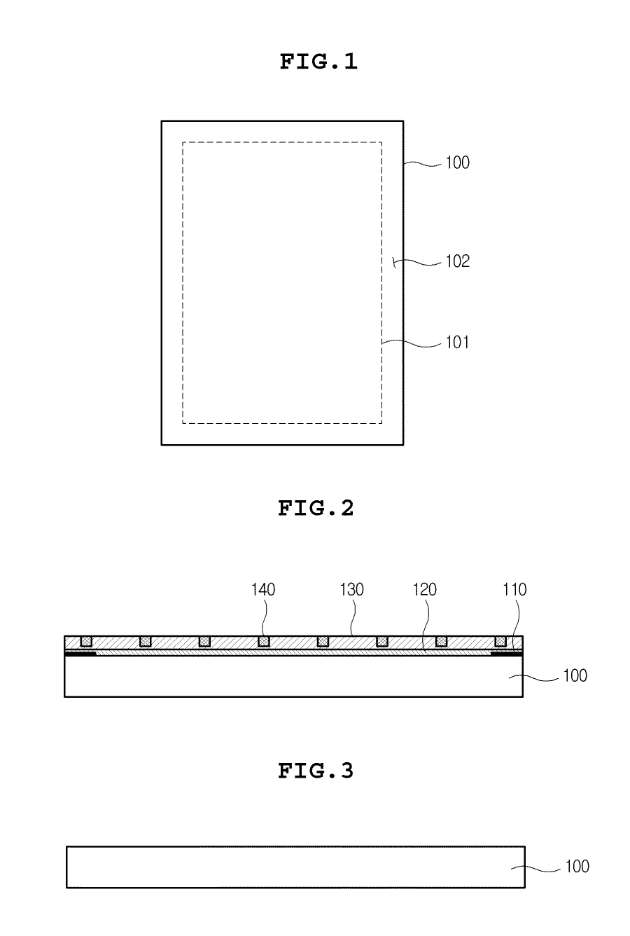

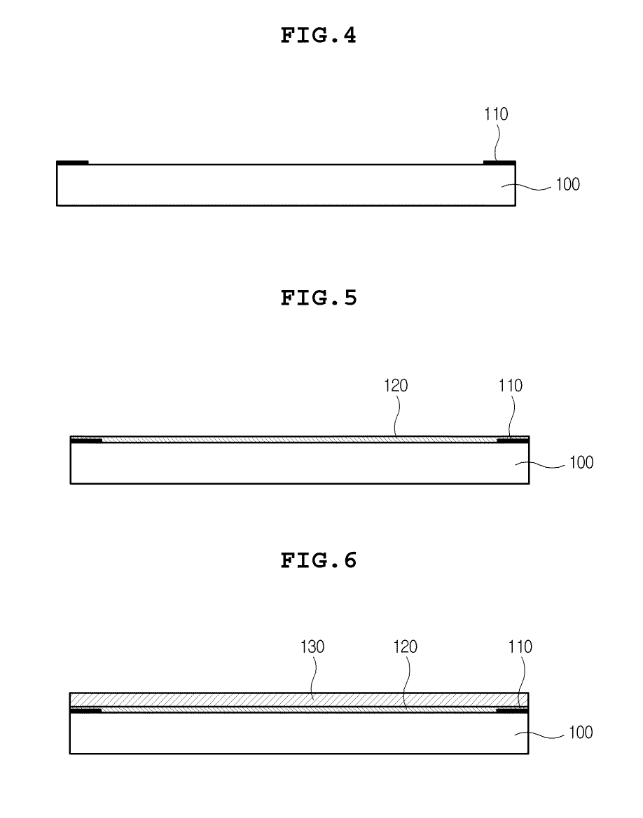

FIG. 1 is a plan view illustrating a transparent substrate included in a touch panel according to an embodiment of the present invention, and FIG. 2 is a cross-sectional view of the touch panel according to an embodiment of the present invention.

As illustrated in FIGS. 1 and 2, a touch panel according to an embodiment of the present invention may include a transparent substrate 100 divided into an active region 101 and a non-active region 102 as an edge of the active region 101, a printing layer 110 formed in the non-active region 102 of one surface of the transparent substrate 100, an adhesive film 120 formed to cover the printing layer 110 on one surface of the transparent substrate 100, an insulating layer 130 formed on one surface of the adhesive film 120 and having an intaglio portion 131 (or intaglio portions 131) open toward one surface thereof, and an electrode 140 (or electrodes 140) formed in the intaglio portion 131.

The transparent substrate 100 is required to be transparent allowing a user to recognize an image provided from an image display device. In consideration of transparency, preferably, the transparent substrate 100 is made of polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, a polyimide (PI) film, polystyrene (PS), biaxially oriented PS (BOPS) (containing K resin), glass, tempered glass, or the like, but the present invention is not necessarily limited thereto.

Meanwhile, the transparent substrate 100 may be a window glass provided on the outermost side of the touch panel. When the transparent substrate 100 is a window glass, since the electrode 140 as described hereinafter is formed on the window glass, a process of forming an electrode on a transparent substrate and attaching the transparent substrate with the electrode to the window glass may be omitted in a process of manufacturing a touch panel, and thus, the overall thickness of the touch panel can be reduced.

As shown in FIG. 1, the transparent substrate 100 may be divided into the active region 101 and the non-active region 102 as an edge region of the active region 101. The active region 101 may be a region in which a user's touch operation is performed and the user visually checks an operational scene of the device. The non-active region 102 is a region covered by the printing layer 110 as described hereinafter formed on the transparent substrate 100, so as not to be exposed to the outside.

The printing layer 110 is formed in the non-active region 102 of one surface of the transparent substrate 100. The printing layer 110 may be formed on the transparent substrate 100 through various printing methods such as a screen printing method, a spin coating method, and the like, by using color ink, or the like.

The printing layer 110 may serve as a wiring (not shown) disposed in a region corresponding to the non-active region 102 of the transparent substrate 100. The printing layer 110 may be a decorative pattern such as a logo of a product maker as necessary.

The adhesive film 120 may be formed on one surface of the transparent substrate 100 such that it covers the printing layer 110. The adhesive film 120 may cover the printing layer 110 and the active region 101 of one surface of the transparent substrate 100 as illustrated.

The adhesive film 120 may include a silane coupling agent, and may be formed by applying a silane coupling agent to one surface of the transparent substrate 100 in a spray manner. Here, the adhesive film 120 may be formed such that the entirety of one surface thereof is a planarized surface. Since the entirety of one surface of the adhesive film 120 is planarized, a step formed due to the printing layer 110 may be eliminated. In this case, however, one surface of the adhesive film 120 may not necessarily be a planarized surface. The adhesive film 120 may be formed such that a portion thereof covering the printing layer 110 is convex and a portion covering the active region 101 of one surface of the transparent substrate 100 is slightly depressed. Although the portion of the adhesive film 120 covering the active region 101 of one surface of the transparent substrate 100 is slightly depressed, the depressed space may be filled by the insulating layer 130 as described hereinafter.

The insulating layer 130 is laminated on one surface of the adhesive film 120. The insulating layer 130 may include an intaglio portion 131 formed to be open toward one surface of the insulating layer 130 through a method such as a transfer process, or the like, as described hereinafter. The insulating layer 130 may include a thermosetting resin or UV-curing resin.

The insulating layer 130 may be integrated with the transparent substrate 100 with excellent adhesive strength by the virtue of the foregoing adhesive film 120 interposed between the insulating layer 130 and one surface of the transparent substrate 100. Also, in comparison to a case in which the electrode 140 is directly formed on one surface of the transparent substrate 100, the electrode 140 is not affected by a step caused by the printing layer 110 during a formation process thereof. In other words, since a step caused by the printing layer 110 is buried by the adhesive film 120 and the insulating layer 130, the electrode 140 is not affected by a step caused by the printing layer 110 during a process in which the electrode 140 is formed on the insulating layer 130. Thus, a disconnection, or the like, of the electrode 140 due to a step does not occur.

The electrode 140 generates a signal when touched by a user to allow a controller (not shown) to recognize touch coordinates. The signal generated from the electrode 140 is transferred to the controller (not shown) through a wiring.

The electrode 140 is formed to be buried within the intaglio portion 131 of the insulating layer 130. Here, the electrode 140 may be formed through an evaporation process using sputtering, e-beam evaporation, or the like, or through a plating process, or the like.

When the electrode 140 is formed through a plating process, a seed layer (not shown) may be formed on an inner surface of the intaglio portion 131 before the electrode 140 is formed.

Since the electrode 140 is formed to be buried in the intaglio portion 131, it may be supported by an inner surface of the intaglio portion 131. Thus, the touch panel according to the present embodiment can have enhanced durability, in comparison to the related art touch panel in which an electrode is formed to be protruded from a transparent substrate.

Meanwhile, the electrode 140 may be made of a metal of any one of copper (Cu), aluminum (Al), gold (Au), silver (Ag), titanium (Ti), palladium (Pd), and chromium (Cr), or any combination thereof. However, the electrode 140 is not limited to these types of metals, and any metal that has high electrical conductivity and is easily processed may be used to form the electrode 140. Also, since the electrode 140 is made of a metal, it may be formed to have a mesh pattern in order not to mar light transmittance of the touch panel due to the opaque characteristics of the metal.

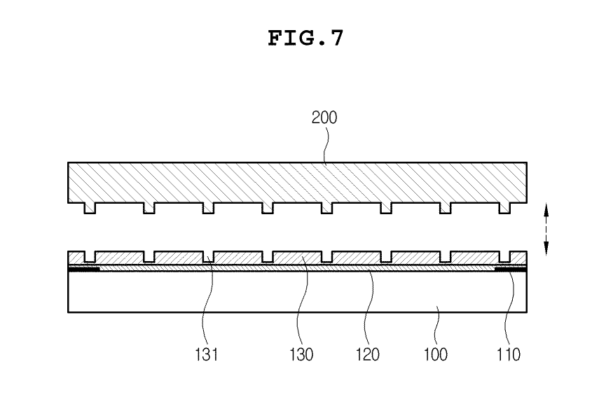

A method for manufacturing a touch panel according to the present embodiment will be described with reference to the accompanying drawings. FIGS. 3 to 7 are cross-sectional views sequentially showing a process of manufacturing a touch panel illustrated in FIG. 2.

A method for manufacturing a touch panel according to the present embodiment includes step (A) of preparing the transparent substrate 100, step (B) of forming the printing layer 110 on the non-active region 102 of one surface of the transparent substrate 100, step (C) of forming the adhesive film 120 on one surface of the transparent substrate 100 such that it covers the printing layer 110, step (D) of forming the insulating layer 130 on one surface of the adhesive film 120, step (E) of forming the intaglio portion 131 on one surface of the insulating layer 130, and step (F) of forming the electrode 140 within the intaglio portion 131.

As shown in FIG. 3, in step (A), the transparent substrate 100 is prepared. The transparent substrate 100 may be made of the foregoing material having transparency. The transparent substrate 100 may be window glass provided on the outermost portion of the touch panel. The transparent substrate 100 may be divided into the active region 101 and the non-active region 102 (See FIG. 1).

As shown in FIG. 4, in step (B), the printing layer 110 is formed in the non-active region 102 of one surface of the transparent substrate 100. The printing layer 110 is formed in the non-active region 102 of one surface of the transparent substrate 100. The printing layer 110 may be formed on the transparent substrate 100 through various methods such as applying a photosensitive resin such as color ink, or the like, to one surface of the transparent substrate 100 through various printing methods such as a screen printing method, a spin-coating method, and the like, and exposing and developing the same.

As shown in FIG. 5, in step (C), the adhesive film 120 is formed on one surface of the transparent substrate 100.

The adhesive film 120 is formed on one surface of the transparent substrate 100 such that it covers the printing layer 110 and the active region 101 of one surface of the transparent substrate 100. The adhesive film 120 may include a silane coupling agent, and may be formed by applying a silane coupling agent to one surface of the transparent substrate 100 in a spray manner.

As shown in FIG. 6, in step (D), the insulating layer 130 is formed on one surface of the adhesive film 120.

The insulating layer 130 may include the intaglio portion 131 formed to be open toward one surface of the insulating layer 130 through a transfer process, or the like, as described hereinafter. The insulating layer 130 may include a thermosetting resin or a UV-curing resin.

The insulating layer 130 may be formed on one surface of the adhesive film 120 through various printing processes, and may be made of a thermosetting resin or a UV-curing resin so as to be cured by heat or light (UV light) after undergoing a patterning process (to be described).

As shown in FIG. 7, in step (E), the intaglio portion 131 is formed on one surface of the insulating layer 130.

In this process, in order to form the intaglio portion 131 on the insulating layer 130, a stamp may be used. The intaglio portion 131 may be formed by transferring a stamp onto the insulating layer 130 in a thickness direction of the insulating layer 130. Here, the intaglio portion 131 may be formed by making the stamp penetrate the insulating layer 130, or as illustrated, it may be formed such that a residue remains, rather than allowing the stamp to penetrate the insulating layer 130.

The electrode 140 as described hereinafter is formed in the intaglio portion 131. Thus, preferably, the insulating layer 130 is patterned in consideration of the pattern of the electrode 140. The stamp may be configured as, for example, a flat type stamp 200. Although not shown, a circular stamp may also be used.

After being patterned by the stamp, the insulating layer 130 is cured. A method for curing the insulating layer 130 may differ according to a material of the insulating layer 130. When the insulating layer 130 is made of a thermosetting resin, the insulating layer 130 is cured by heat, and when the insulating layer 130 is made of a UV-curing resin, the insulating layer 130 is cured by light (UV light).

In step (F), the electrode 140 is formed within the intaglio portion 131 of the insulating layer 130.

The electrode 140 may be formed through an evaporation process using sputtering, e-beam evaporation, or the like, or through a plating process, or the like. When the electrode 140 is formed through a plating process, a seed layer (not shown) may be formed on an inner surface of the intaglio portion 131 before the formation of the electrode 140.

The electrode 140 may be made of a metal of any one of copper (Cu), aluminum (Al), gold (Au), silver (Ag), titanium (Ti), palladium (Pd), and chromium (Cr), or any combination thereof.

According to the preferred embodiments of the present invention, since the adhesive film including a silane coupling agent is interposed between the insulating layer and the transparent substrate, the insulating layer can be integrated with the transparent substrate with excellent adhesive strength thereof.

Also, since a step caused by the printing layer is covered by the adhesive film and the insulating layer, there is no influence due to the step in the process of forming the electrode, eliminating a disconnection problem of the electrode as formed.

In addition, since the electrode is formed to be buried in the intaglio portion formed on the insulating layer and supported by the inner surface of the intaglio portion, the electrode can be prevented from being released from the insulating layer, thus enhancing durability of the touch panel.

Although the embodiments of the present invention have been disclosed for illustrative purposes, it will be appreciated that the present invention is not limited thereto, and those skilled in the art will appreciate that various modifications, additions, and substitutions are possible, without departing from the scope and spirit of the invention.

Accordingly, any and all modifications, variations, or equivalent arrangements should be considered to be within the scope of the invention, and the detailed scope of the invention will be disclosed by the accompanying claims.

What is claimed is:

1. A touch panel comprising:
a transparent substrate divided into an active region and a non-active region as an edge of the active region;
a printing layer formed in the non-active region of one surface of the transparent substrate;
an adhesive film formed to cover the printing layer on one surface of the transparent substrate;
an insulating layer formed on one surface of the adhesive film and having an intaglio portion open toward one surface thereof; and
an electrode formed within the intaglio portion.

2. The touch panel as set forth in claim 1, wherein the adhesive film includes a silane coupling agent.

3. The touch panel as set forth in claim 1, wherein the insulating layer is made of a thermosetting resin or a UV-curing resin.

4. The touch panel as set forth in claim 1, wherein the electrode is made of a metal of any one of copper (Cu), aluminum (Al), gold (Au), silver (Ag), titanium (Ti), palladium (Pd), and chromium (Cr), or any combination thereof.

5. The touch panel as set forth in claim 1, wherein the transparent substrate is window glass.

6. A method for manufacturing a touch panel, the method comprising:
(A) preparing a transparent substrate;
(B) forming a printing layer on a non-active region of one surface of the transparent substrate;
(C) forming an adhesive film on one surface of the transparent substrate such that it covers the printing layer;
(D) forming an insulating layer on one surface of the adhesive film;
(E) forming an intaglio portion on one surface of the insulating layer; and
(F) forming an electrode within the intaglio portion.

7. The method as set forth in claim 6, wherein the adhesive film includes a silane coupling agent.

8. The method as set forth in claim 6, wherein, in (C), the adhesive film is formed by applying a silane coupling agent in a spray manner to one surface of the transparent substrate.

9. The method as set forth in claim 6, wherein the insulating layer is made of a thermosetting resin or a UV-curing resin.

10. The method as set forth in claim 6, wherein, in (E), the intaglio portion is formed by patterning the insulating layer with a stamp.

11. The method as set forth in claim 6, wherein the electrode is made of a metal of any one of copper (Cu), aluminum (Al), gold (Au), silver (Ag), titanium (Ti), palladium (Pd), and chromium (Cr), or any combination thereof.

12. The method as set forth in claim 6, wherein, in (F), the electrode is formed by evaporating or plating a metal within the intaglio portion.

13. The method as set forth in claim 6, wherein the transparent substrate is window glass.
